(19) United States
(12) Patent Application Publication
(10) Pub. No.: US 2021/0311421 A1
(43) Pub. Date: Oct. 7, 2021

(54) IMAGE FORMING APPARATUS

(71) Applicant: Konica Minolta, Inc., Tokyo (JP)

(72) Inventor: Masataka YAGI, Okazaki-shi (JP)

(21) Appl. No.: 17/180,181

(22) Filed: Feb. 19, 2021

(30) Foreign Application Priority Data
Apr. 3, 2020 (JP) 2020-067364

(51) Int. Cl. G03G 15/20

(52) U.S. Cl. CPC G03G 15/2039; G03G 15/2028

(57) ABSTRACT

There is provided an image forming apparatus that heat-fixes a toner image by passing a recording sheet through a fixing nip, and the image forming apparatus includes: a heater that raises a temperature of a fixing member forming the fixing nip; and a determiner that determines, by using at least one of a heat storage state of a peripheral member that affects a temperature rise rate of the fixing member and a power supply voltage of the image forming apparatus, a print wait period until the recording sheet is caused to enter the fixing nip after a target temperature for temperature control of the fixing member is switched to a heat fixing temperature such that the recording sheet enters the fixing nip before the temperature of the fixing member is raised to exceed an allowable temperature range.

The entire disclosure of Japanese patent Application No. 2020-067364, filed on Apr. 3, 2020, is incorporated herein by reference in its entirety.

### BACKGROUND

### Technological Field

The present disclosure relates to an image forming apparatus, and more particularly to a technique for preventing overheating of a fixing member that heat-fixes a toner image on a recording sheet.

### Description of the Related Art

In the electrophotographic image forming apparatus, when a pressure member is used to press-contact a recording sheet carrying a toner image to a high-temperature fixing member, the toner image is melted and pressed onto the recording sheet. In recent years, innovations have been added in which in order to speed up the fixing process, a large amount of electric power is applied to shorten the time required for raising the temperature of the fixing member, and in order to save this electric power, the heat capacity of the fixing member is reduced. In this way, a first copy out time (FCOT) can be shortened, so that a printed matter can be provided quickly without making the user of the image forming apparatus wait.

However, when the heat capacity of the fixing member is reduced, the temperature of the fixing member is easily fluctuated. As a result, when the temperature of the fixing member deviates from an appropriate temperature range and becomes low, toner particles cannot be sufficiently softened, and fixing failure may occur.

The pressure member has a larger heat capacity than the fixing member. For example, in a case where the pressure member is a pressure roller having an elastic layer provided on the outer peripheral surface of a core metal, and the fixing member is a metal fixing belt, the heat capacity of the pressure roller is considerably larger than that of the fixing belt.

Therefore, even when the temperature of the fixing member is within the appropriate temperature range, in a case where the temperature of the pressure member is not sufficiently raised, and a temperature difference between the pressure member and the fixing member is large, the amount of heat absorbed from the fixing member by the pressure member increases. Thus, when the recording sheet is passed through a fixing nip, the heat absorption by the recording sheet and the heat absorption by the pressurizing member combine so that the temperature of the fixing member is significantly lowered beyond the lower limit of the appropriate temperature range, and fixing failure may occur.

In response to such a problem, for example, a technique is proposed which monitors the temperature of a fixing member and passes the recording sheet through the fixing nip after the temperature of the fixing member rises above a predetermined temperature from the lower limit of the appropriate temperature range (see, for example, JP 10-333485 A).

In this way, as compared with a case where the recording sheet is passed through the fixing nip at the timing when the temperature of the fixing member reaches the lower limit of the appropriate temperature range, the temperature of the pressure member can be raised in the time until starting passing the recording sheet. Thus, it is possible to suppress the temperature drop of the fixing member due to the endothermic effect of the pressure member.

The temperature of the fixing member is higher than the lower limit of the appropriate temperature range. Thus, the temperature of the fixing member can be maintained within the appropriate temperature range even when the temperature of the fixing member is lowered by passing the recording sheet. Therefore, it is possible to prevent the occurrence of fixing failure due to the temperature drop of the fixing member.

When the temperature of the fixing member is easily fluctuated by reducing the heat capacity of the fixing member, an overshoot in which the temperature of the fixing member deviates from the appropriate temperature range and becomes high easily occurs. When the overshoot occurs, the toner particles are thermally melted and, spot-off occurs, which may deteriorate an image quality. Further, when the overshoot occurs repeatedly, the fixing member and the pressure member may deteriorate acceleratively over time or be damaged.

In response to such a problem, the above-described related art allows the temperature of the fixing member to be higher than the upper limit of the appropriate temperature range. Thus, for example, in FIG. 2 of JP 10-333485 A, the fixing member is warmed up until the temperature of the fixing member reaches a temperature TFS higher than an upper limit TFH of the appropriate temperature range, so that the overshoot cannot be avoided.

### SUMMARY

The present disclosure has been made in view of the above-described problems, and an object thereof is to provide an image forming apparatus which is capable of preventing an occurrence of overshoot in a case where a temperature of a fixing member having a small heat capacity is raised at a high speed.

To achieve the abovementioned object, according to an aspect of the present invention, there is provided an image forming apparatus that heat-fixes a toner image by passing a recording sheet through a fixing nip, and the image forming apparatus reflecting one aspect of the present invention comprises: a heater that raises a temperature of a fixing member forming the fixing nip; and a determiner that determines, by using at least one of a heat storage state of a peripheral member that affects a temperature rise rate of the fixing member and a power supply voltage of the image forming apparatus, a print wait period until the recording sheet is caused to enter the fixing nip after a target temperature for temperature control of the fixing member is switched to a heat fixing temperature such that the recording sheet enters the fixing nip before the temperature of the fixing member is raised to exceed an allowable temperature range.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a main configuration of an image forming apparatus according to an embodiment of the present disclosure;

FIG. 2 is a table for summarizing specifications regarding a conveying timing of a recording sheet S in an image forming apparatus;

FIG. 3 is a diagram illustrating a main configuration of a fixing device;

FIG. 4 is a block diagram illustrating a main configuration of a controller;

FIG. 5 is a plan view illustrating a main configuration of an operation panel;

FIG. 6 is a flowchart illustrating a control operation of the fixing device by the controller;

FIG. 7 is a timing chart illustrating an image forming operation of the image forming apparatus in a case where a print wait time is 4.0 seconds;

FIG. 8 is a timing chart illustrating the image forming operation of the image forming apparatus in a case where the print wait time is 2.0 seconds;

FIG. 9 is a graph illustrating a temperature change of the fixing belt when a control target value of the temperature of the fixing belt is switched from a preliminary rotation temperature Ts to a print set temperature Ti;

FIG. 10 is a graph illustrating a temperature rise rate of the fixing belt after start of the temperature rise;

FIG. 11 is a flowchart illustrating a process of estimating a temperature rise rate by the controller;

FIG. 12 is a table illustrating a temperature rise rate table which stores a surface temperature x of the pressure roller and a temperature rise rate R in association with each other;

FIG. 13A is a graph illustrating a temperature change of the fixing belt in a case where a timing of the recording sheet S entering the fixing nip is late;

FIG. 13B is a graph illustrating the temperature change of the fixing belt in a case where the timing of the recording sheet S entering the fixing nip is advanced;

FIG. 13C is a graph illustrating the temperature change of the fixing belt in a case where an amount of heat stored in the fixing device is small;

FIG. 14 is a graph illustrating the temperature of the fixing belt at a temperature rise start timing in a case where a preliminary rotation period is sufficiently long under normal temperature;

FIG. 15 is a graph illustrating the temperature of the fixing belt at the temperature rise start timing in a case where an environmental temperature is low, and a preliminary rotation period is short;

FIG. 16A is a table for describing heat generation indexes A and B and heat dissipation index C;

FIG. 16B is a table for describing a calculation method of a heat storage index x;

FIG. 16C is a graph illustrating a change of the heat storage index x over time;

FIG. 17 is a table illustrating a temperature rise rate table in which a numerical range of the heat storage index x and a temperature rise rate R are associated with each other;

FIG. 18A is a graph illustrating the temperature change of the fixing belt in a case where the print wait time is fixed regardless of a preliminary rotation time;

FIG. 18B is a graph illustrating the temperature change of the fixing belt in a case where the print wait time is adjusted according to the preliminary rotation time;

FIG. 19 is a table illustrating a print wait time table in which a numerical range of a preliminary rotation time x and the print wait time are associated with each other;

FIG. 20A is a graph illustrating the temperature rise rate in a case where a power supply voltage of an external power supply supplying power to the image forming apparatus is 100V;

FIG. 20B is a graph illustrating the temperature rise rate in a case where the power supply voltage of the external power supply supplying power to the image forming apparatus is 90V; and

FIG. 21 is a table illustrating a print wait time table in which the print wait time is associated with a combination of the numerical range of the preliminary rotation time x and a numerical range of a power supply voltage D.

### DETAILED DESCRIPTION OF EMBODIMENTS

Hereinafter, one or more embodiments of the present invention will be described with reference to the drawings. However, the scope of the invention is not limited to the disclosed embodiments.

### [1] Configuration of Image Forming Apparatus

First, the configuration of the image forming apparatus according to this embodiment will be described.

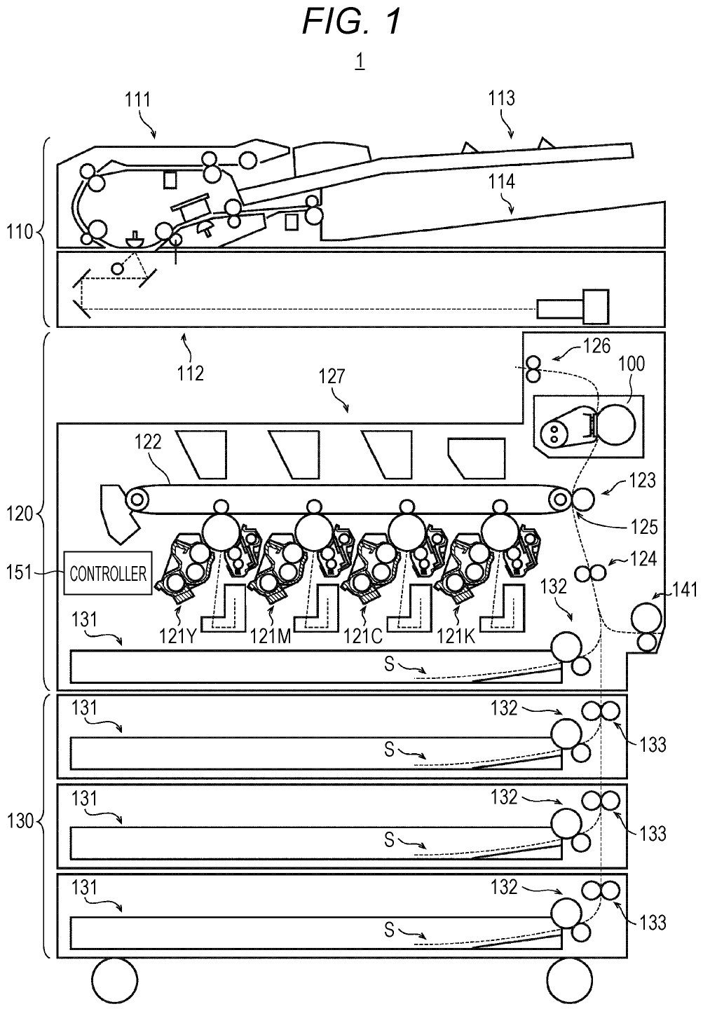

As illustrated in FIG. 1, the image forming apparatus 1 is a so-called tandem type color multi-function peripheral (MFP), and includes an image reading part 110, an image forming part 120, and a sheet feeding part 130.

The image reading part 110 includes an automatic document feeder (ADF) 111 and a scanner device 112. In a case where originals are read by a sheet-through method, the automatic document feeder 111 feeds out and conveys the originals one by one from an original bundle placed on an original tray 113 and causes the scanner device 112 to read the originals to generate image data. Thereafter, the originals are discharged onto an output tray 114. In a case where the originals are read by a platen set method, the scanner device 112 reads the original placed on a platen glass (not illustrated).

The image forming part 120 forms an image by using the image data generated by the image reading part 110 and the image data received from another device by the controller 151. In this embodiment, imaging parts 121Y, 121M, 121C and 121K form toner images of colors of yellow (Y), magenta (M), cyan (C) and black (K), respectively.

The toner images of YMCK colors formed by the imaging parts 121Y, 121M, 121C and 121K are sequentially electrostatically transferred (primary transfer) so as to be aligned and overlapped with each other in an intermediate transfer belt 122, thereby forming the color toner image. The intermediate transfer belt 122 is an endless belt and travels around to convey a color toner image to a secondary transfer nip 125 formed by a secondary transfer roller pair 123.

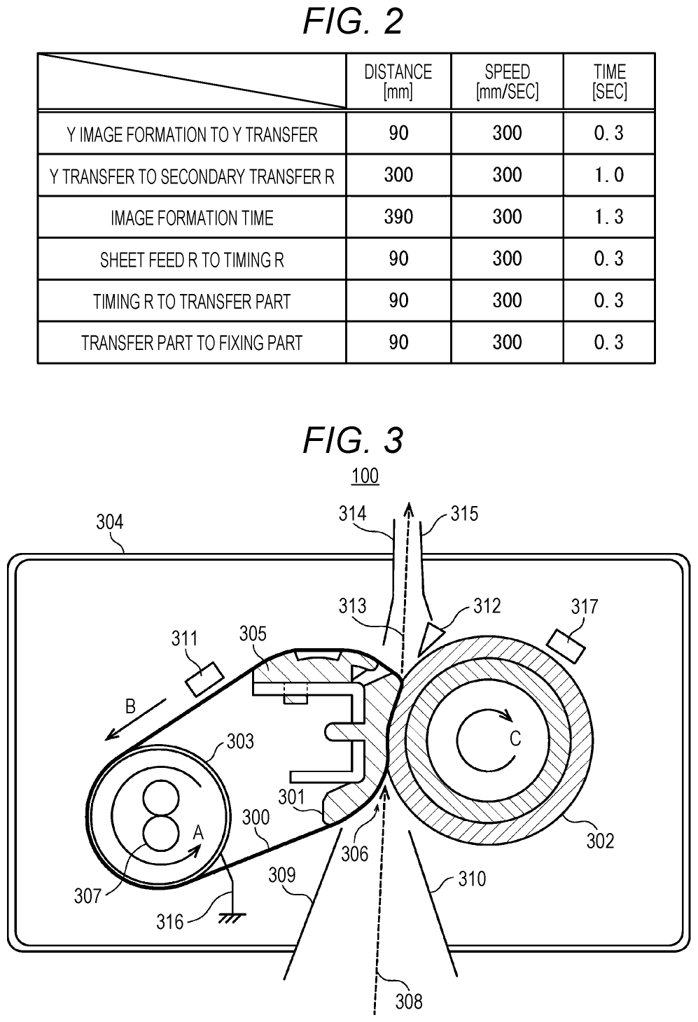

As illustrated in FIG. 2, in this embodiment, a so-called system speed is set to 300 mm/sec. Therefore, the speed at which the intermediate transfer belt 122 travels around is 300 mm/sec, and the speed at which a recording sheet S is conveyed is also 300 mm/sec. Further, the distance by which the intermediate transfer belt 122 travels around from the start of image formation of the Y color toner image in the imaging part 121Y to the primary transfer of the corresponding Y color toner image to the intermediate transfer belt 122 is 90 mm, and the required time therefor is 0.3 seconds (=90 mm/300 mm per second).

The traveling distance of the intermediate transfer belt 122 from the primary transfer of the Y color toner image to the secondary transfer of the corresponding Y color toner image is 300 mm, and the required time therefor is 1.0 second (=300 mm/300 mm per second). The total of 1.3 seconds is called an image formation time. Since the toner image of each MCK color forms a color toner image together with the Y color toner image and is 30 secondarily transferred, the primary transfer and the secondary transfer are performed during this image formation time.

In parallel with the image formation process as described above, a sheet feed roller 132 feeds out a sheet S from a sheet feed cassette 131 containing the sheet S of the type specified by a user. The sheets S contained in the second to fourth-stage sheet feed cassettes 131 are fed out by the sheet feed rollers 132 and then conveyed toward a timing roller pair 124 by a vertical conveying roller 133.

The sheet S fed in this way is conveyed to the secondary transfer nip 125 in accordance with the secondary transfer timing after skew is corrected by bringing the tip of the sheet S into contact with the timing roller pair 124 and forming a loop.

The secondary transfer nip 125 is formed by pressing two rollers of the secondary transfer roller pair 123 to each other with the intermediate transfer belt 122 sandwiched therebetween. A secondary transfer bias is applied between the two rollers in the secondary transfer roller pair 123, and in at the secondary transfer nip 125, the color toner image carried by the intermediate transfer belt 122 is electrostatically transferred to the sheet S (secondary transfer).

The sheet S to which the color toner image is secondarily transferred is conveyed to the fixing device 100, and the color toner image is heat-fixed. Then, the sheet is discharged to the output tray 127 by an output roller pair 126.

As illustrated in FIG. 2, the conveying distance by which the recording sheet S is fed out from the sheet feed roller 132 until the tip thereof reaches the timing roller pair 124 is 90 mm, and the required time is 0.3 seconds (=90 mm/300 mm per second). The conveying distance by which the recording sheet S is fed out from the timing roller pair 124 until the tip thereof reaches the secondary transfer nip 125 of the secondary transfer roller pair 123 is also 90 mm, and the required time is 0.3 seconds (=90 mm/300 mm per second).

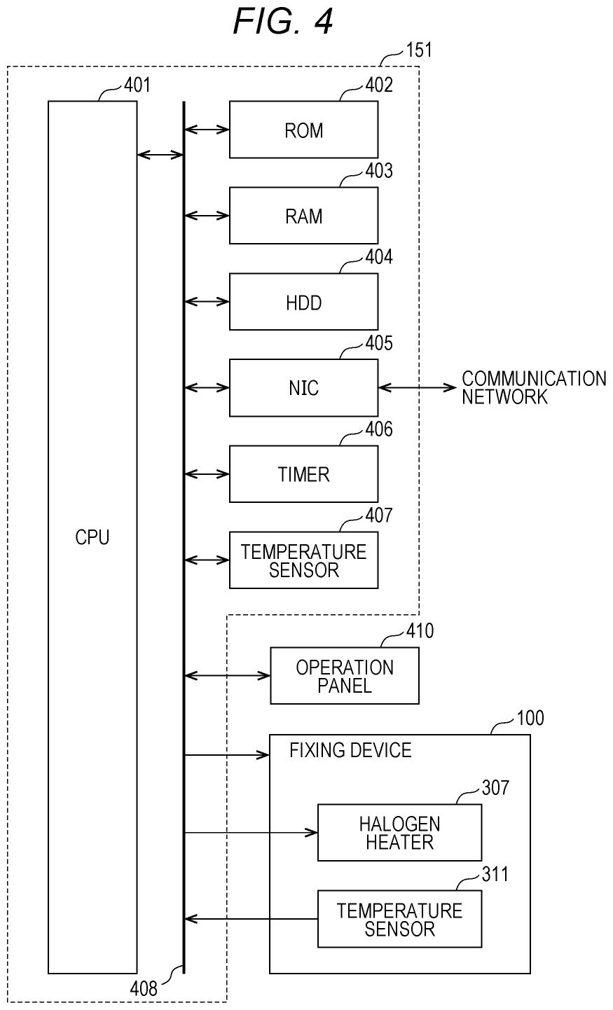

The conveying distance by which the recording sheet S is fed out from the secondary transfer roller pair 123 until the tip thereof reaches the fixing nip 306 (see FIG. 3) of the fixing device 100 is also 90 mm, and the required time is 0.3 seconds (=90 mm/300 mm per second).

The controller 151 monitors and controls the operation of each part of the image forming apparatus 1.

### [2] Configuration of Fixing Device 100

Next, the configuration of the fixing device 100 will be described.

The fixing device 100 is a so-called upper two-axis belt fixing system, and as illustrated in FIG. 3, has a configuration in which a fixing belt 300, a fixing pad 301, a pressure roller 302, a heating roller 303, and the like are provided in a housing 304. The fixing belt 300 is hung around the fixing pad 301, the heating roller 303, and the belt support member 305. The fixing belt 300 is a belt having a low heat capacity and a small diameter of φ40 mm.

The heating roller 303 has a hollow cylindrical shape, is made of a metal material such as aluminum (Al), steel use stainless (SUS), and iron (Fe), and has high thermal conductivity. A halogen heater 307 is arranged inside the heating roller 303. When the halogen heater 307 is turned on, the heating roller 303 is heated, so that the portion of the fixing belt 300 in contact with the heating roller 303 is heated.

When the pressure roller 302 is rotationally driven in the direction of arrow C, the fixing belt 300 is driven by the pressure roller 302 to rotate and travel in the direction of arrow B. The range of the fixing belt 300 coming into contact with the heating roller 303 fluctuates in accordance with this rotation traveling, and thus the entire fixing belt 300 is heated evenly. A temperature sensor 311 detects the surface temperature of the fixing belt 300.

The fixing pad 301 is provided with a fluorine layer on the surface on which the fixing belt 300 is in sliding contact. The fluorine layer reduces the frictional resistance when the fixing belt 300 slides on the fixing pad 301. As the fluorine layer, a fluorine sheet, a sheet obtained by impregnating a woven glass fiber cloth with fluorine, or the like can be used. Considering wear resistance, it is desirable to use an insulating fluororesin.

The pressure roller 302 is pressure-contacted to the fixing pad 301 with the fixing belt 300 sandwiched therebetween, whereby the fixing nip 306 is formed. Further, the heating roller 303 rotates in the direction of arrow Aby following the rotation traveling of the fixing belt 300 in the direction of arrow B. The temperature sensor 317 detects the temperature of the outer peripheral surface of the pressure roller 302. The temperature of the outer peripheral surface of the pressure roller 302 is used to estimate the temperature rise rate R [° C. per second] of the fixing belt 300 as will be described later.

The recording sheet S entering the fixing device 100 along a conveying path 308 is guided to the fixing nip 306 by conveying guides 309 and 310. A peeling claw 312 is arranged on the downstream side of the fixing nip 306 in a sheet conveying direction to prevent the recording sheet S having passed through the fixing nip 306 from winding around the pressure roller 302. After passing through the fixing nip 306, the recording sheet S which separates from the fixing device 100 along a conveying path 313 is guided to the outside of the fixing device 100 by conveying guides 314 and 315.

Incidentally, in order to prevent electrostatic offset, the inner peripheral surface of the fixing belt 300 is conductive, and the conductive heating roller 303 coming into contact with the inner peripheral surface of the fixing belt 300 is electrically grounded. Specifically, both the cylindrical portion and the rotation shaft of the heating roller 303 are made of a conductive material and are electrically connected to each other. Since the rotation shaft of the heating roller 303 is electrically connected to a grounding circuit 316, the inner peripheral surface of the fixing belt 300 is grounded via the cylindrical portion and the rotation shaft of the heating roller 303 and the grounding circuit 316.

Among the members arranged around the fixing belt 300, the fixing pad 301 and the pressure roller 302 are indirect contact with the fixing belt 300. Further, the support member of the fixing pad 301 and the rotation shaft of the pressure roller 302 are supported by the housing 304. Further, the housing 304 is directed to the main body of the image forming apparatus 1.

That is, the fixing pad 301, the pressure roller 302, and the housing 304 form a heat conduction path for releasing the heat of the fixing belt 300 to the main body of the image forming apparatus 1. In this sense, the fixing pad 301, the pressure roller 302, and the housing 304 are peripheral members which affect the temperature rise rate of the fixing belt 300.

### [3] Configuration of Controller 151

Next, the configuration of the controller 151 will be described.

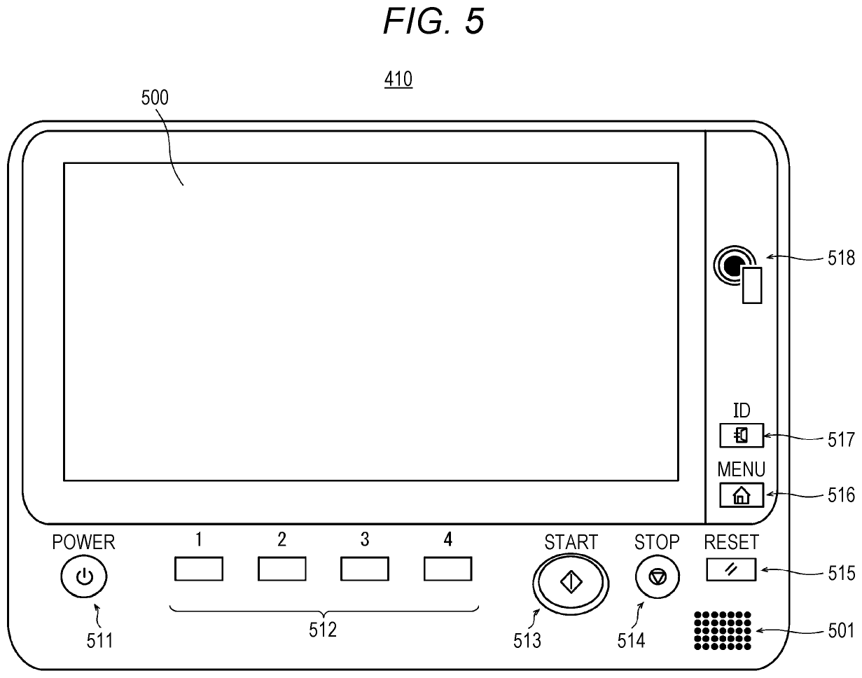

As illustrated in FIG. 4, in the controller 151, a central processing unit (CPU) 401, a read only memory (ROM) 402, a random access memory (RAM) 403, and the like connected in an internal bus 408 to communicate with each other. When a reset signal is input due to a power supply or the like to the image forming apparatus 1, the CPU 401 reads a boot program from the ROM 402 and starts up and executes an operating system (OS) and a control program read from a hard disk drive (HDD) 404 with the RAM 403 used as a work storage area.

A network interface card (NIC) 405 executes processing for communicating with other devices via a communication network such as a local area network (LAN) or the Internet. Accordingly, the image forming apparatus can accept an image forming job or the like from another apparatus.

A timer 406 is used by the controller 151 for timing, and in this embodiment, the timer is particularly used for timing a print wait time Δt of the fixing device. The temperature sensor 407 is used to acquire an environmental temperature, and in this embodiment, the in-apparatus temperature of the image forming apparatus 1 is measured as the environmental temperature. However, needless to say, the present disclosure is not limited to this, and an outside temperature may be measured as the environmental temperature.

The controller 151 uses the operation panel 410 to provide information to the user of the image forming apparatus 1 and to receive an instruction input from the user.

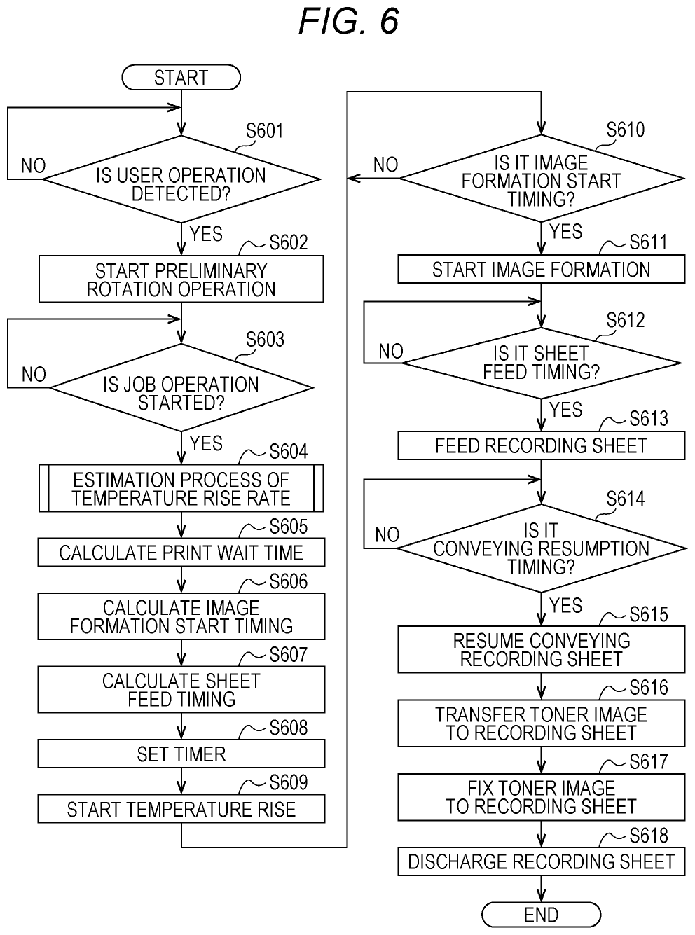

As illustrated in FIG. 5, the operation panel 410 includes a touch panel 500, a speaker 501, a power key 511, a hard key 512, a startkey 513, a stop key 514, a reset key 515, a menu key 516, and an ID key 517. The touch panel 500 includes a liquid crystal display (LCD) and a touch pad, and displays the screen to the user or accepts touch input by the user. The speaker 501 is used to output audio to the user.

The power key 511 is a key for turning on the power of the image forming apparatus 1, and the hard key 512 is customized by the user to set a function to be executed when pressed. The start key 513 is a key for starting the execution of jobs after the user completes the setting of the execution conditions of jobs such as copying. The stop key 514 is a key for stopping a running job. The reset key 515 is a key for resetting setting on a displayed screen.

The menu key 516 is a key for displaying a top menu. The ID key 517 is a key for starting an authentication process when the operation panel 410 is in a log-out state and for logging out when the operation panel is in a login state. Further, the operation panel 410 includes a short-range wireless communication interface 518 for linking with a mobile terminal or the like.

With reference to the output signal of the temperature sensor 311 of the fixing device 100, the controller 151 acquires the surface temperature of the fixing belt 300 and turns on or off the halogen heater 307 to control the surface temperature of the fixing belt. In addition to these, the controller 151 starts the state of other parts of the image forming part 120 such as the imaging parts 121Y, 121M, 121C and 121K, the image reading part 110, and the sheet feeding part 130, and controls the operations thereof.

### [4] Operation of Controller 151

Next, the operation of the controller 151 will be described with particular attention to the print wait time Δt.

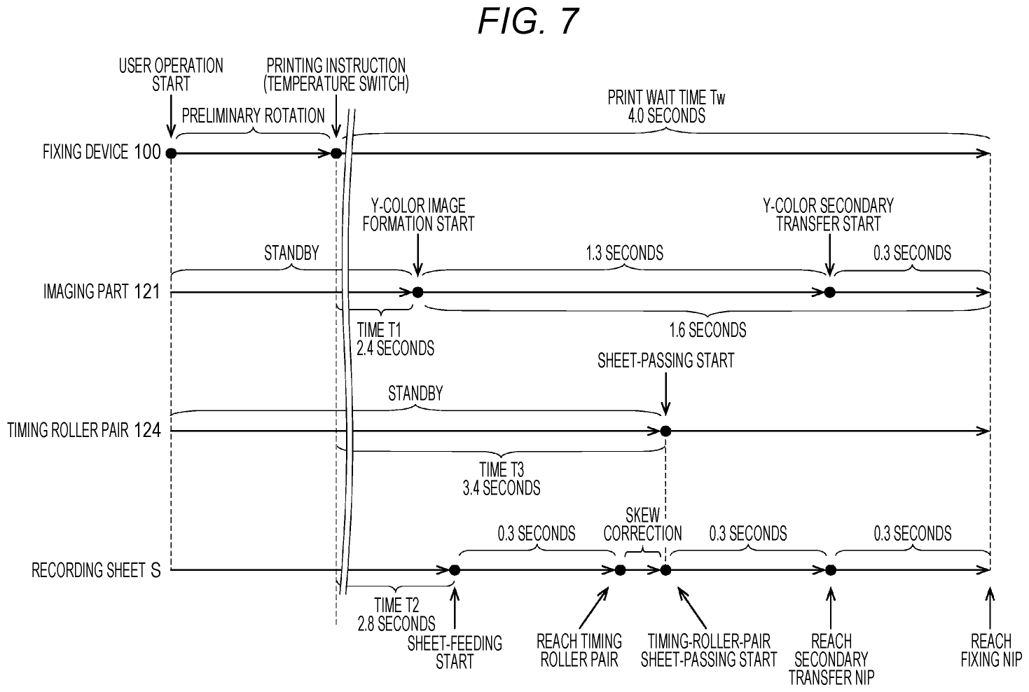

FIG. 6 is a flowchart for describing the operation of the controller 151 regarding the first page in a case where the user of the image forming apparatus 1 operates the operation panel 410 to form an image of a plurality of pages. Incidentally, in a case where the number of pages to be image-formed is only one, the same applies to the operation of the controller 151 regarding the corresponding one page. Further, in a case where an image forming job is received from another apparatus via the communication network, the operation of the controller 151 starts from step S604 in FIG. 6.

As illustrated in FIG. 6, when the controller 151 detects a user operation on the operation panel 410 (S601: YES), the controller 151 starts a preliminary rotation operation of the fixing device 100 (S602). The preliminary rotation operation of the fixing device 100 is an operation to raise the temperature of the fixing belt 300 with a temperature (referred to as a “preliminary rotation temperature Ts”) lower than the temperature (referred to as a “print set temperature Ti”) of the fixing belt at the time of fixing defined as a control target value.

Thereafter, when the user of the image forming apparatus 1 presses the start key 513 of the operation panel 410 to instruct the start of job execution (S603: YES), a process of estimating the temperature rise rate R of the fixing belt 300 is executed as described later (S604), and the print wait time Δt is calculated from the temperature rise rate R obtained by estimation (S605). The print wait time Δt is a set value of the time since the temperature rise is started with the target temperature of the fixing belt 300 set as the print set temperature Ti until the tip of the recording sheet S enters the fixing nip 306.

In this embodiment, the print wait time Δt is calculated using the following equation (1).

Print wait time Δt={Print set temperature Ti−Preliminary rotation temperature Ts}/Temperature rise rate R (1)

For example, in a case where the environmental temperature is 25° C., the estimation value of the temperature rise rate R of the fixing belt 300 is 4° C./sec, the print set temperature Ti is 176° C., and the preliminary rotation temperature Ts is 160° C., the print wait time Δt is

$$Δ t = \{ 176 ° C . - 160 ° C . \} / 4 ° C . / sec = 4.0 seconds . \qquad ( 2 )$$

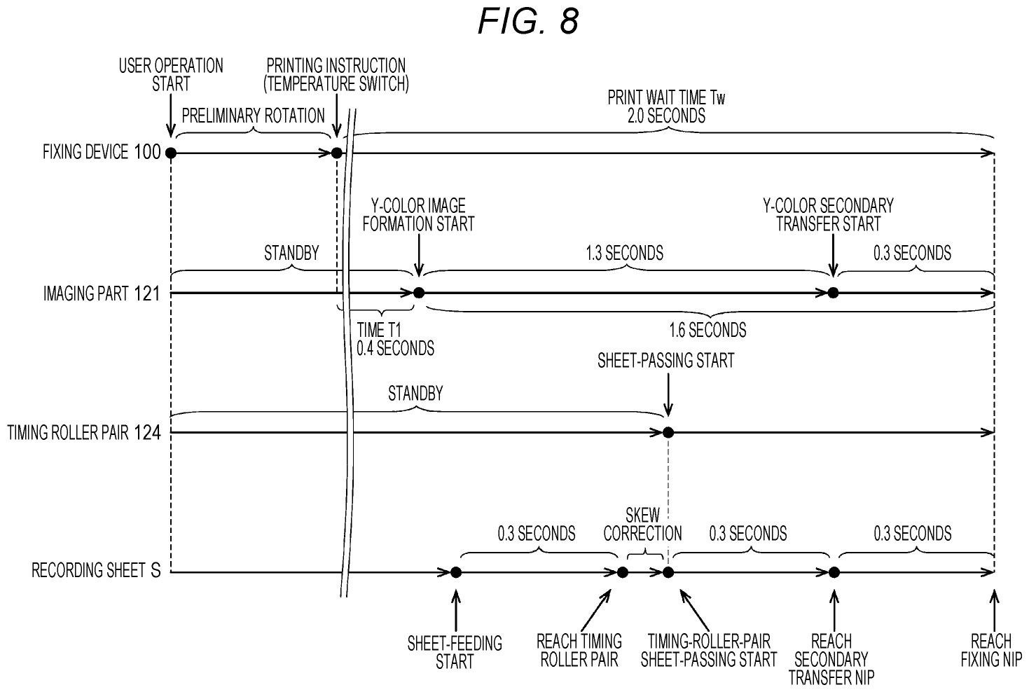

Next, the timing to start imaging is calculated (S606). In this embodiment, as illustrated in FIG. 7, the time required for the recording sheet S carrying the toner image to enter the fixing nip 306 after the imaging part 121Y starts the imaging of the Y-color toner image is 1.6 seconds which is obtained by adding 0.3 seconds which is the time taken for the recording sheet S to be conveyed from the secondary transfer roller pair 123 to the fixing nip 306 to the above-described image formation time of 1.3 seconds. Time T1 obtained by subtracting this time from the print wait time Δt is

T1=4.0 seconds−1.6 seconds=2.4 seconds (3).

Therefore, the image formation start timing is 2.4 seconds after the start of the temperature rise of the fixing belt 300.

Next, the sheet feed timing of the recording sheet S is calculated (S607). As illustrated in FIG. 2, the time required for the recording sheet S to enter the fixing nip 306 via the timing roller pair 124 and the secondary transfer roller pair 123 after the start of sheet feeding 0.9 seconds (=0.3 seconds+0.3 seconds+0.3 seconds) or more in consideration of performing skew-correction or waiting to adjust the print position on the recording sheet S. Therefore, in comparison with the value obtained by subtracting this time from the print wait time Δt, time T2 is set such that

T2<4.0 seconds−0.9 seconds=3.1 seconds (4).

For example, T2 may be set to 2.8 seconds with a margin of 0.3 seconds.

Further, the timing at which the timing roller pair 124 starts passing a sheet is time T3 which is obtained by rewinding the time of the recording sheet S entering the fixing nip 306 by the time taken for the recording sheet S to enter the fixing nip 306 after the timing roller pair 124 starts passing the sheet. Thus,

T3=4.0 seconds−(0.3 seconds+0.3 seconds)=3.4 seconds (5).

After the calculation of times T1, T2 and T3, these times are set to timer 406 (S608) and the temperature rise of the fixing belt 300 is started (S609).

When time T1 (=2.4 seconds) elapses after the start of the temperature rise of the fixing belt 300 (S610: YES), the imaging parts 121Y, 121M, 121C and 121K are controlled to start image formation in order from the Y color toner image (S611).

When time T2 (2.8 seconds in the above example) elapses after the start of the temperature rise of the fixing belt 300 (S612: YES), the sheet feeding part 130 is controlled to start the sheet feeding of the recording sheet (S613).

When time T3 (=3.4 seconds) elapses after the start of the temperature rise of the fixing belt 300 (S614: YES), the timing roller pair 124 are rotationally driven to start passing the recording sheet S (S615).

Thereafter, in the recording sheet S, the toner image carried on the outer peripheral surface of the intermediate transfer belt 122 is secondarily transferred at the secondary transfer nip 125 (S616), and the toner image is heat-fixed at the fixing nip 306 (S617) and then discharged to the outside of the apparatus (S618).

When the members configuring the fixing device 100 are warm as in a case where the next image forming job is executed immediately after the previous image forming job is completed or a case where the preliminary rotation time is sufficiently long, the temperature rise rate R is increased. For example, in a case where the environmental temperature is 25° C., the estimation value of the temperature rise rate R of the fixing belt 300 is 8° C./sec, the print set temperature Ti is 176° C., and the preliminary rotation temperature Ts is 160° C., the print wait time Δt is

Δt={176° C.−160° C.}/8° C./sec=2.0 seconds (6).

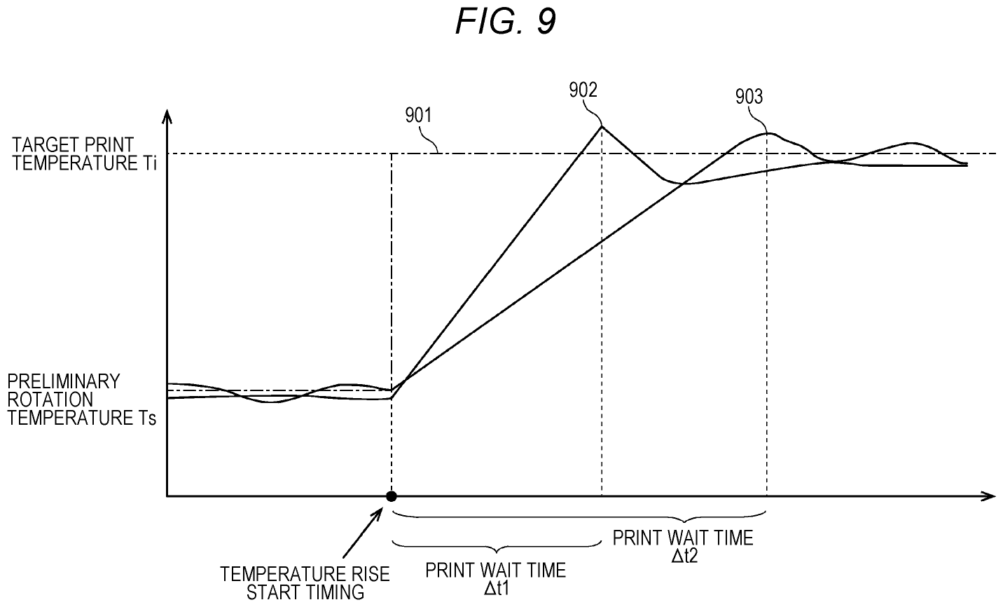

As illustrated in FIG. 8, in the timing of starting image formation, the time required for the recording sheet carrying the toner image to enter the fixing nip 306 after the imaging part 121Y starts the imaging of the Y-color toner image is 1.6 seconds which is obtained by adding 0.3 seconds which is the time taken for the recording sheet S to be conveyed from the secondary transfer roller pair 123 to the fixing nip 306 to the above-described image formation time of 1.3 seconds. Time T1 obtained by subtracting this time from the print wait time Δt is

T1=2.0 seconds−1.6 seconds=0.4 seconds (7).

Therefore, the image formation start timing is 0.4 seconds after the start of the temperature rise of the fixing belt 300.

In the timing of feeding the recording sheet S, the time required for the recording sheet S to enter the fixing nip 306 via the timing roller pair 124 and the secondary transfer roller pair 123 after the start of sheet feeding 0.9 seconds (=0.3 seconds+0.3 seconds+0.3 seconds) or more in consideration of performing skew-correction or waiting to adjust the print position on the recording sheet S. Therefore, in comparison with the value obtained by subtracting this time from the print wait time Δt, time T2 is set such that

T2<2.0 seconds−0.9 seconds=1.1 seconds (8).

For example, T2 may be set to 2.8 seconds with a margin of 0.3 seconds.

Further, the timing at which the timing roller pair 124 starts passing a sheet is time T3 which is obtained by rewinding the time of the recording sheet S entering the fixing nip 306 by the time taken for the recording sheet S to enter the fixing nip 306 after the timing roller pair 124 starts passing the sheet. Thus,

T3=2.0 seconds−(0.3 seconds+0.3 seconds)=1.4 seconds (9).

The processing after determining times T1, T2 and T3 is the same as above.

In this way, the recording sheet S enters the fixing nip 306 at the timing when the print wait time Δt elapses after the start of the temperature rise of the fixing belt 300, and thus it is possible to prevent the overshoot of the temperature of the fixing belt 300.

### [5] Estimating Process (S504) of Temperature Rise Rate R

Next, the estimation process of the temperature rise rate R will be described.

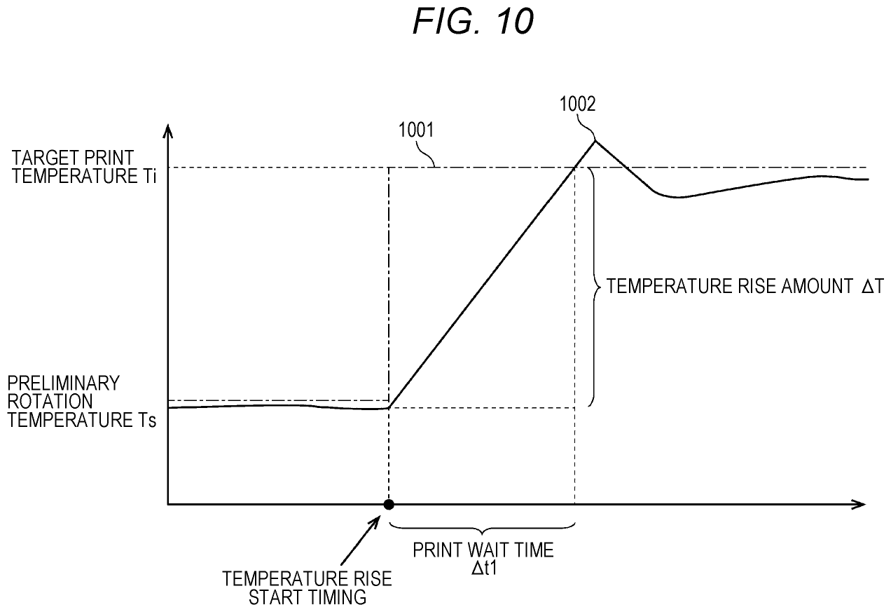

FIG. 9 is a graph illustrating the temperature change of the fixing belt 300 when the control target value of the temperature of the fixing belt 300 is switched from the preliminary rotation temperature Ts to the print set temperature Ti. A vertical axis represents the temperature of the fixing belt 300, and a horizontal axis represents an elapsed time. Further, line graph 901 shows the control target value of the temperature of the fixing belt 300.

As illustrated in FIG. 9, in a case where the amount of heat stored in the members configuring the fixing device 100 such as the pressure roller 302 is large, and the temperature is considerably high, the time until the temperature of the fixing belt 300 reaches the print set temperature Ti after the temperature rise start timing when the control target value of the temperature of the fixing belt 300 is switched from the preliminary rotation temperature Ts to the print set temperature Ti becomes shorter as shown in graph 902. That is, the temperature rise rate R of the fixing belt 300 is high.

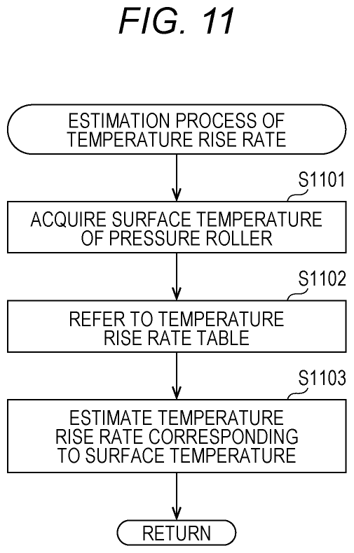

As illustrated in FIG. 10, the temperature rise rate R of the fixing belt 300 is obtained by dividing the temperature rise amount ΔT by the print wait time Δt. Before the temperature rise start timing, the temperature of the fixing belt 300 is adjusted to be the preliminary rotation temperature Ts. Further, the temperature of the fixing belt 300 immediately after the print wait time Δt elapses is the print set temperature Ti. Therefore, the temperature rise amount ΔT is

ΔT=Ti−Ts (10).

Therefore, the temperature rise rate R is

R=ΔT/Δt=(Ti−Ts)/Δt (11).

Incidentally, even after the temperature of the fixing belt 300 reaches the print set temperature Ti, the temperature of the fixing belt 300 continues to rise at the temperature rise rate R until the recording sheet S reaches the fixing nip 306. Thus, particularly in a case where the temperature rise rate R is high, the possibility of overshoot increases.

On the other hand, in a case where the amount of heat stored in the members configuring the fixing device 100 is not large, and the temperature is not so high, the time until the temperature of the fixing belt 300 reaches the print set temperature Ti becomes longer as shown in graph 903 of FIG. 9. Therefore, the temperature rise rate R of the fixing belt 300 is low. As described above, the temperature rise rate R of the fixing belt 300 depends on the amount of heat stored in the members configuring the fixing device 100.

Therefore, when the recording sheet S is conveyed such that the time from the temperature rise start timing to the entry of the recording sheet S into the fixing nip 306 is constant regardless of the heat storage state of the members configuring the fixing device 100, the overshoot occurs easily particularly in a case where the temperature rise rate R is high. Therefore, in order to prevent the occurrence of overshoot, it is necessary to adjust the entry timing of the recording sheet S according to the heat storage state of the members configuring the fixing device 100.

In this embodiment, the temperature rise rate R of the fixing belt 300 is estimated by referring to the surface temperature of the pressure roller 302, which is considered to have a large influence particularly on the temperature rise rate R due to the direct contact with the fixing belt 300, among the members configuring the fixing device 100 as an index value for indexing the heat storage state of the members configuring the fixing device 100.

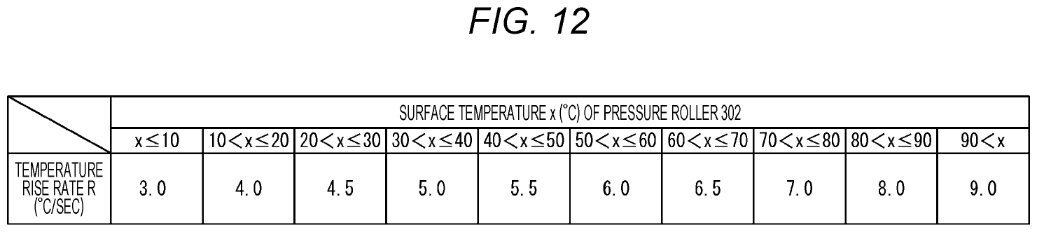

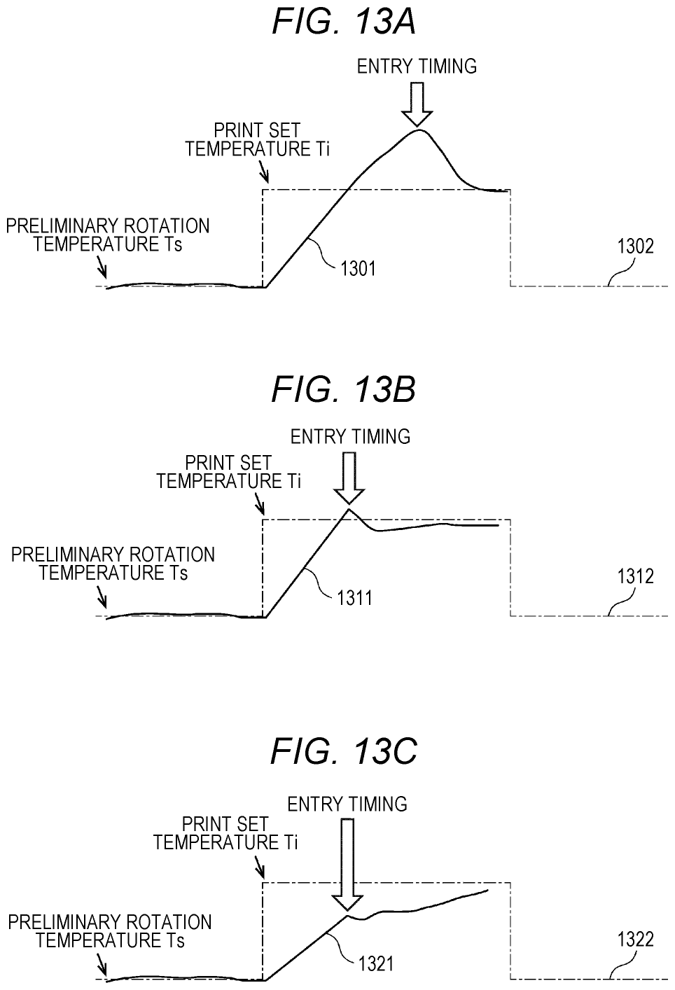

That is, as illustrated in FIG. 11, in the process of estimating the temperature rise rate, first, the surface temperature of the pressure roller 302 is acquired by referring to the output signal of the temperature sensor 317 (S1101), and then with reference to the temperature rise rate table (S1102), the temperature rise rate corresponding to the surface temperature of the pressure roller 302 is estimated (S1103). As illustrated in FIG. 12, the temperature rise rate table is a table in which the range of the surface temperature of the pressure roller 302 and the temperature rise rate R of the fixing belt 300 are stored in association with each other.

The numerical value in each column of the temperature rise rate table can be determined, for example, by measurement with experiments. For example, the temperature rise rate table may be stored in the HDD 404 of the controller 151 or may be stored in the ROM 402. Further, the temperature rise rate table may be stored in another non-volatile memory.

For example, in a case where the surface temperature of the pressure roller 302 is higher than 70° C. and lower than 80° C., the temperature rise rate R of the fixing belt 300 from the temperature rise start timing to the entry of the recording sheet S to the fixing nip 306 can be estimated to be 7.0° C. per second.

Needless to say, the stored contents of the temperature rise rate table are not limited to FIG. 12, and it is desirable to specify the numerical values stored in the temperature rise rate table by experiments for each image forming apparatus to which the present disclosure is applied. Further, as a matter of course, instead of the temperature rise rate table, a function that outputs the surface temperature R of the pressure roller 302 as an independent variable and the temperature rise rate R of the fixing belt 300 as a dependent variable may be used.

### [6] Suppression of Overshoot

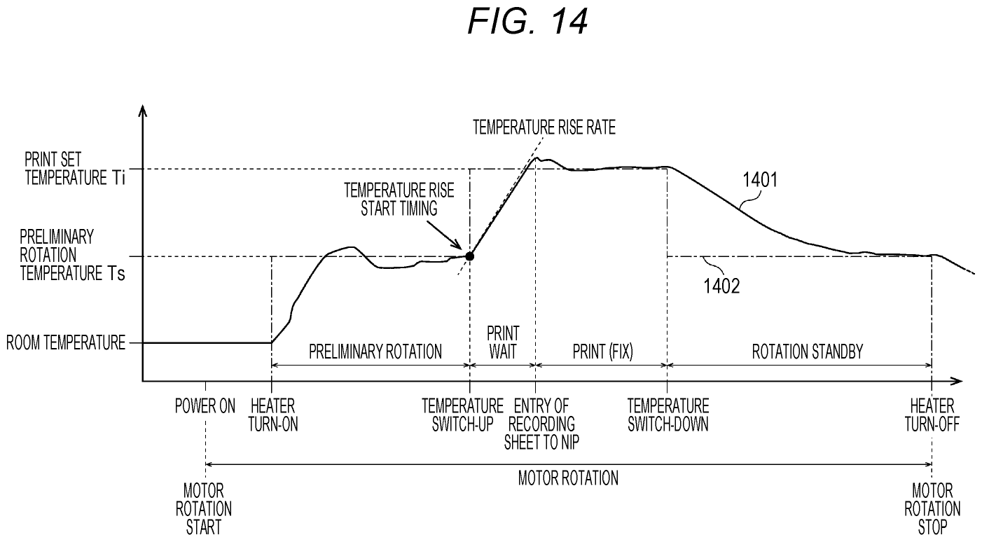

For example, in the fixing device 100 according to this embodiment, in a fixing pad type of fixing device which is a high-speed machine with a system speed of 300 mm per second and uses a fixing belt having a low heat capacity and a small diameter (D40 mm), when the amount of heat applied to the fixing belt is increased due to the need to control the temperature of the belt at high speed, the temperature fluctuation (ripple) of the fixing belt tends to increase. In particular, in the temperature control before printing the first sheet of the job, the temperature rise width of the fixing belt is large, so that the temperature fluctuation becomes large, and there is a risk that an overshoot occurs in which the temperature of the fixing belt exceeds the upper limit of an allowable range. In particular, in a state where the fixing device is warmed after continuous printing (=a state where the heat storage amount is large), the temperature rise rate of the fixing belt is faster than that in a state where the fixing device is not warmed. Thus, the overshoot occurs further easily, and for example, as illustrated in FIG. 13A, the width of the overshoot easily becomes large.

In response to such a problem, a countermeasure can be considered which prevents an overshoot by causing the recording sheet S to enter the fixing nip before the temperature of the fixing belt exceeds the upper limit of the allowable range so that the overshoot occurs and absorbing heat from the fixing belt to the recording sheet S. In a case where the heat capacity of the fixing belt is low, the temperature lowering width of the fixing belt due to the heat absorption of the recording sheet S can be secured sufficiently largely. Thus, this method is particularly effective in that case.

Therefore, even in a case where the amount of heat stored in the fixing device is large, and the temperature rise rate is high, as illustrated in FIG. 13B, when the first recording sheet S of the job is caused to enter the fixing nip in accordance with the timing when the temperature of the fixing belt reaches the print set temperature Ti, the overshoot can be suppressed.

However, the timing for causing the first recording sheet S of the job to enter the fixing nip is uniformly advanced regardless of the amount of heat stored in the fixing device, which has an adverse effect. For example, immediately after the power is turned on to the image forming apparatus, especially in a case where the environmental temperature is low such as in winter, the amount of heat stored in the fixing device is small, and thus it takes time to raise the temperature of the fixing belt. In such a case, when the timing of causing the recording sheet S to enter the fixing nip is advanced, for example, as illustrated in FIG. 13C, the fixing belt is not sufficiently heated, so that fixing failure may occur.

In response to such a problem, in this embodiment, the temperature rise rate of the fixing belt 300 is estimated from the measured value of the surface temperature of the pressure roller 302 at the temperature rise start timing of the fixing belt 300, and the entry timing of the recording sheet S is determined such that the timing of causing the recording sheet S to enter the fixing nip 306 is advanced when the temperature rise rate of the fixing belt 300 increases. Therefore, it is possible to suppress both the occurrence of overshoot in which the temperature rise of the fixing belt 300 is excessive and the fixing failure caused by insufficient temperature rise of the fixing belt 300.

Incidentally, in this embodiment, it is assumed that the environmental temperature is room temperature (25° C.) since the image forming apparatus 1 is often installed in an air-conditioned room such as an office. In a case where the environmental temperature is room temperature, the temperature of the fixing belt 300 can be set to be the preliminary rotation temperature Ts at the temperature rise start timing by performing preliminary rotation.

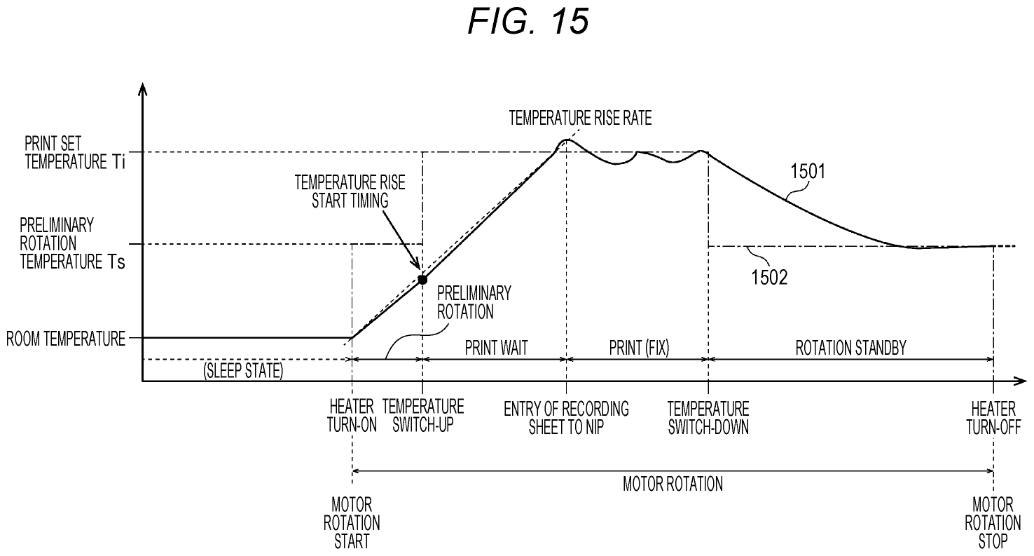

In the example of FIG. 14, a vertical axis represents a temperature, and a horizontal axis represents the passage of time. The temperature of the fixing belt 300 represented by graph 1401 is the same temperature as the room temperature (for example, 25° C.) until the halogen heater 307 is turned on. After the halogen heater 307 is turned on, the temperature of the fixing belt 300 is controlled to be the preliminary rotation temperature Ts, and the temperature is close to the preliminary rotation temperature Ts at the temperature rise start timing.

Herein, the preliminary rotation is a control operation for controlling the temperature while rotating the fixing belt 300 so that fixing can be performed at any time when a printing instruction comes. Incidentally, in consideration of energy saving, the target temperature (preliminary rotation temperature Ts) for temperature control during the preliminary rotation is set to be lower than the print set temperature Ti. In this embodiment, the print set temperature Ti is 176° C. while the preliminary rotation temperature Ts is 160° C.

As described above, at the temperature rise start timing, the fixing belt 300 reaches approximately the preliminary rotation temperature Ts, and in order to cause the recording sheet S to enter the fixing nip 306 at the timing when the temperature of the fixing belt 300 rises to the print set temperature Ti, the time obtained by dividing the temperature difference obtained by subtracting the preliminary rotation temperature Ts from the print set temperature Ti by the temperature rise rate may be defined as the print wait time Δt.

In this embodiment, the temperature rise rate is estimated by using the surface temperature of the pressure roller 302, but the temperature rise rate may be estimated by using another method as described later. Further, since the temperature difference obtained by subtracting the preliminary rotation temperature Ts from the print set temperature Ti is constant, the print wait time Δt may be estimated directly from the surface temperature of the pressure roller 302 or the like without estimating the temperature rise rate.

Incidentally, as well as in a case where the temperature rise of the fixing belt 300 is started by the reception or the like of a printing instruction during the preliminary rotation, even in a case where the temperature rise of the fixing belt 300 is started by the reception or the like of a printing instruction during the time of the rotation standby in which the rotation and temperature control of the fixing belt 300 continue during a predetermined time in preparation for the next job after the completion of the image forming job, the occurrence of overshoot can be suppressed by causing the recording sheet S to enter the fixing nip 306 at an appropriate timing in a similar way to this embodiment.

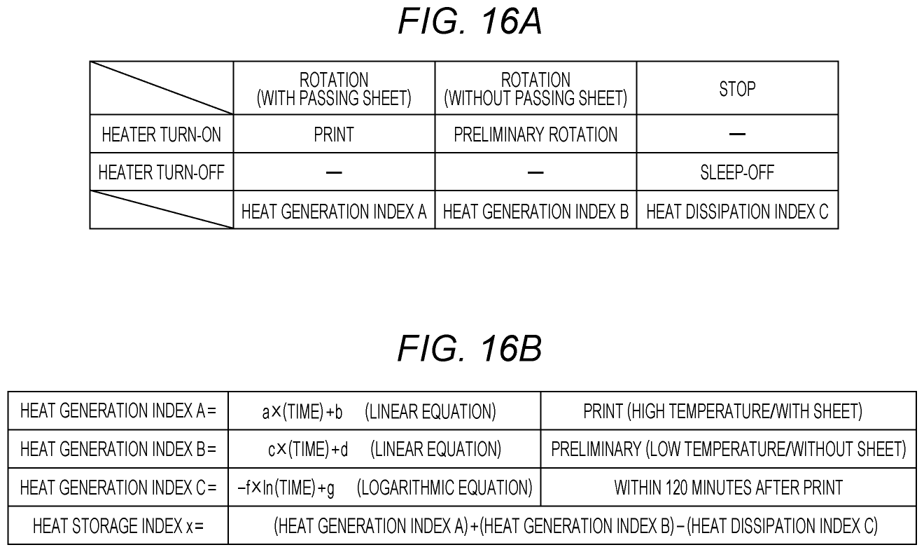

Incidentally, due to the low environmental temperature or the like, the fixing belt 300 may not reach the preliminary rotation temperature Ts at the time (temperature rise start timing) of receiving the printing instruction. Further, even in a case where the halogen heater 307 is turned off, the fixing belt 300 is returned from a sleep mode in which the temperature is not heated or raised, and printing is performed, as illustrated in FIG. 15, the fixing belt 300 may not reach the preliminary rotation temperature Ts at the temperature rise start timing.

In such a case, the time taken for the fixing belt 300 to reach the print set temperature Ti is longer compared to a case where the fixing belt 300 reaches the preliminary rotation temperature Ts at the temperature rise start timing. Thus, in order to accurately suppress the occurrence of overshoot, the print wait time Δt is desirably estimated from the temperature difference between the temperature rise start temperature obtained by measuring the temperature of the fixing belt 300 at the temperature rise start timing and the print set temperature Ti by using the temperature rise rate.

### [7] Modification

Hereinbefore, the present disclosure has been described above based on the embodiment. However, it goes without saying that the present disclosure is not limited to the above-described embodiment, and the following modifications can be implemented.

(7-1) In the above-described embodiment, a case where the temperature rise rate of the fixing belt 300 is estimated by using the surface temperature of the pressure roller 302 has been described as an example. However, needless to say, the present disclosure is not limited thereto, and the temperature rise rate of the fixing belt 300 may be estimated by using the surface temperature of the fixing pad 301 and the temperature of a member which can affect the temperature rise rate of the fixing belt 300 instead of the pressure roller 302.

The temperature rise rate of the fixing belt 300 may be estimated by estimating the heat storage state of the fixing device 100 from the heating rotation information indicating that the fixing belt 300 is rotationally driven while being heated, the sheet passing information indicating that the recording sheet S is passed through the fixing nip 306, the non-operating information indicating that the heating of the fixing belt 300 is stopped, and the like.

For example, a case is considered in which a plain sheet of A4 size with a basis weight of 65 g/m² is fed horizontally (LED: Long Edge Feeding) at the system speed of 300 mm/s, the image formation speed of 60 ppm (Pages Per Minute), and the print setting temperature of 170° C., and one-sided continuous printing is performed.

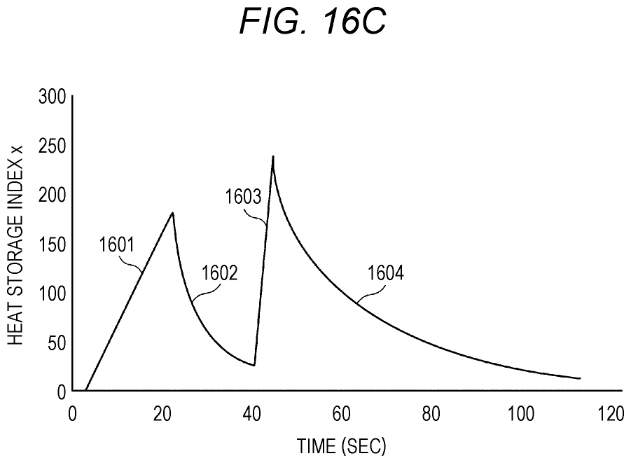

As illustrated in FIG. 16A, the index indicating the amount of heat generated during the printing (fixing) operation of passing a sheet while the fixing belt 300 is rotationally driven after the halogen heater 307 is turned on is set as heat generation index A, and the index indicating the amount of heat generated during the preliminary rotation operation in which the halogen heater 307 is turned on, and the fixing belt 300 is rotationally driven, but a sheet is not passed is defined as heat generation index B. Further, the index indicating that the amount of heat dissipation in a sleep-off state in which the halogen heater 307 is turned off, and the fixing belt 300 is not rotationally driven is defined as heat dissipation index C.

As illustrated in FIG. 16B, heat generation index A is calculated by using linear equation (12) including coefficients a and b, and

(heat generation index A)=a×(time)+b (12)

heat generation index B is calculated by using linear equation (13) including coefficients c and d.

(heat generation index B)=c×(time)+d (13)

Further, heat dissipation index C is calculated by using logarithmic equation (14) including coefficients f and g.

(heat dissipation index C)=−f×ln(time)+g (14)

Here, coefficients a, b, c, d, f, and g are constants determined experimentally. The time is the elapsed time from the start of the printing operation in heat generation index A and is the elapsed time from the start of the preliminary rotation operation in heat generation index B. Further, in heat dissipation index C, the time is the elapsed time from the transition of the operation mode of the image forming apparatus 1 to the sleep-off state.

In logarithmic equation (14), ln is a natural logarithm. However, even when the base of a logarithm such as a common logarithm is a logarithm function different from that of the natural logarithm, the same value can be calculated as heat dissipation index C by adjusting coefficient f according to the difference in the base.

Heat storage index x is calculated by using the following equation (15), which includes heat generation indexes A and B and heat dissipation index C,

(heat storage index x)=(heat generation index A)+(heat generation index B)−(heat dissipation index C) (15).

FIG. 16C is a graph illustrating a change of heat storage index x over time. In FIG. 16C, an aspect in which heat storage index x increases by executing a printing operation for only 16 minutes is shown in graph 1601, then transition is made to the sleep-off state, and an aspect in which heat storage index x decreases when heat dissipation progresses is shown in graph 1602. Further, the preliminary rotation is executed for only four minutes, and the heat storage index x increases again as shown in graph 1603. Then, when transition is made to the sleep-off state, heat storage index x decreases as shown in graph 1604.

Incidentally, as illustrated in FIG. 16B, heat dissipation index C is defined only within 120 minutes after the operation mode of the image forming apparatus 1 transitions to the sleep-off state. In a case where 120 minutes or more elapses after the transition to the sleep-off state, the value of heat storage index x is reset to zero.

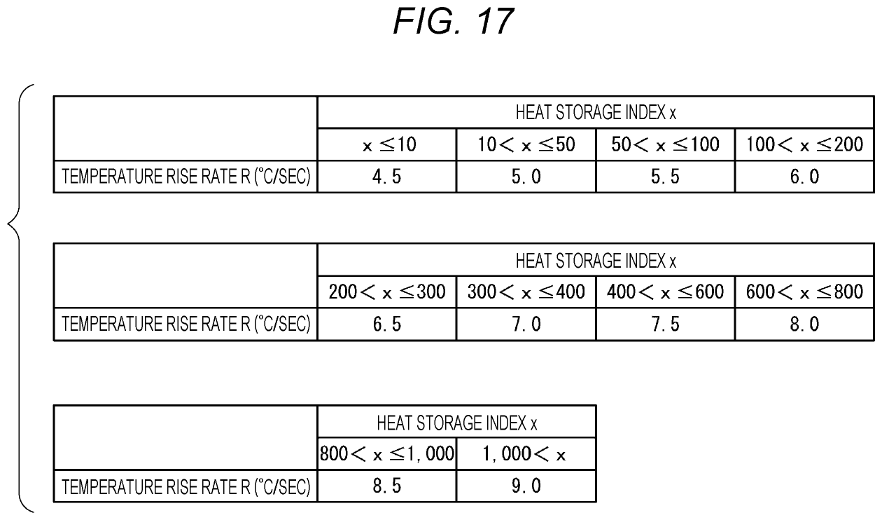

After heat storage index x is specified as described above, the temperature rise rate is estimated with reference to the temperature rise rate table as illustrated in FIG. 17. The temperature rise rate table is a table in which the numerical range of the heat storage coefficient and the temperature rise rate are stored in association with each other. The numerical value in each column of the temperature rise rate table can be determined, for example, by experiment.

When the temperature rise rate is estimated, the numerical range to which heat storage coefficient x specified as described above belongs is specified, and further the temperature rise rate associated with the numerical range in the temperature rise rate table is specified. The process after the temperature rise rate is specified is the same as in step S605 and subsequent steps in FIG. 6.

In this way, the temperature rise rate can be estimated according to the operation history of the image forming apparatus 1, and thus it is possible to accurately suppress the overshoot of the temperature of the fixing belt 300.

(7-2) In the above-described embodiment, a case where the timing of causing the recording sheet S to enter the fixing nip 306 is determined by estimating the temperature rise rate has been described as an example. However, needless to say, the present disclosure is not limited thereto, and the following may be used instead.

That is, the heat storage state of the fixing device 100 mainly depends on the length of the preliminary rotation time until the temperature rise start timing. By paying attention to this characteristic and determining the timing of causing the recording sheet S to enter the fixing nip 306 according to the preliminary rotation time, it is possible to avoid the occurrence of extreme overshoot which cannot be put to practical use.

In a case where the preliminary rotation time is short, the print wait time of about three seconds is sufficient, but when the preliminary rotation time increases, the amount of heat stored in the fixing device 100 increases. For example, in a case where the preliminary rotation time is 20 seconds or more, when the timing of causing the recording sheet S to enter the fixing nip 306 is fixed without advancing, the overshoot occurs.

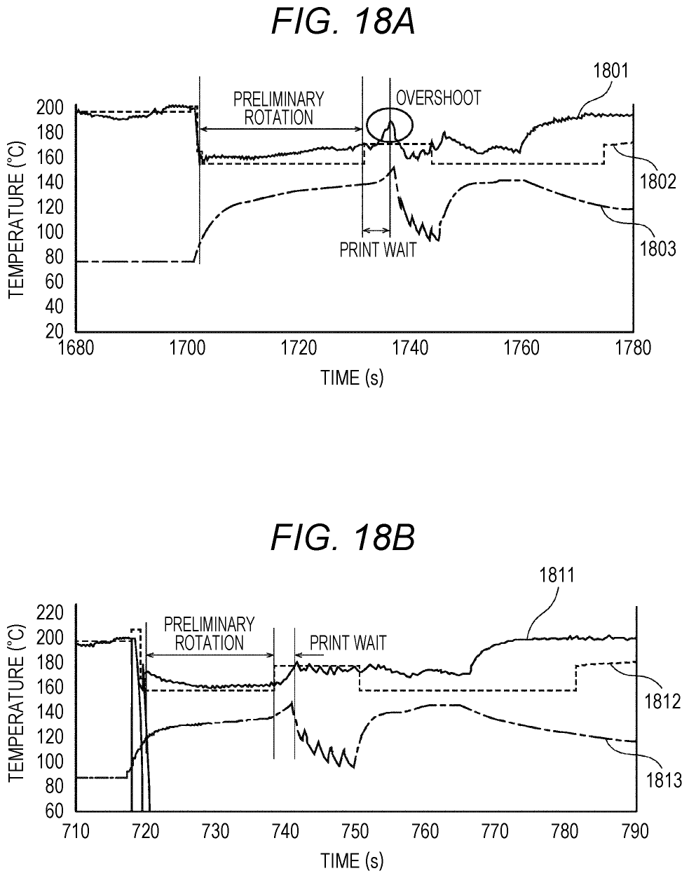

For example, in FIG. 18A, the print wait time is fixed, and thus by the time the recording sheet S enters the fixing nip 306, the overshoot occurs in which the temperature (graph 1801) of the fixing belt 300 is significantly higher than the print set temperature Ti (graph 1802).

When the overshoot occurs, a problem such as uneven gloss of the toner image and separation failure of the recording sheet sticking to the fixing belt 300 easily occurs. In order to suppress the occurrence of overshoot, it is necessary to shorten the print wait time and advance the timing of causing the recording sheet S to enter the fixing nip 306.

For example, in FIG. 18B, the print wait time is set in accordance with the time from when the target value (graph 1812) for temperature control of the fixing belt 300 is switched to the print set temperature Ti until the temperature (graph 1811) of the fixing belt 300 reaches the print set temperature Ti. In accordance with this printing wait time, the recording sheet S enters the fixing nip 306 to absorb heat from the fixing belt 300, and thus the occurrence of overshoot is suppressed.

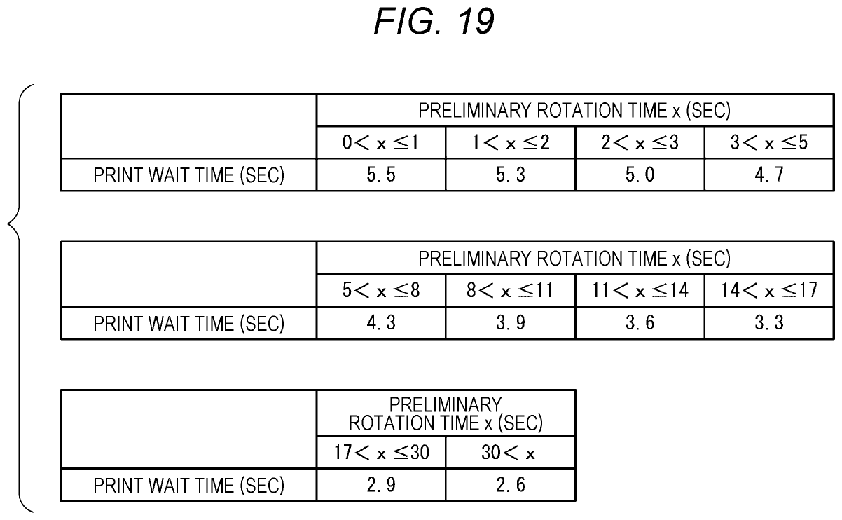

Therefore, as illustrated in FIG. 19, a print wait time table in which the print wait time is associated with the numerical range of the preliminary rotation time until the temperature rise start timing is stored in advance. With reference to the print wait time table, the numerical range to which the preliminary rotation time until the temperature rise start timing belongs may be specified, and the print wait time associated with the numerical range may be specified.

The numerical value in each column of the print wait time table can be determined, for example, by experiment. Further, the print wait time table may be stored in a non-volatile memory such as the ROM 402 or the HDD 404 and read out as needed. The process after the print wait time is specified is the same as in step S606 and subsequent steps in FIG. 6. In this way, the overshoot can be suppressed with high accuracy.

(7-3) In the above-described embodiment, a case where the print wait time is changed according to the heat storage state of the fixing device 100 to suppress the overshoot has been described as an example. However, needless to say, the present disclosure is not limited thereto, and the following may be used instead of or in addition to this.

That is, when the external power supply voltage for supplying power to the image forming apparatus 1 fluctuates, the temperature rise rate of the fixing belt 300 also fluctuates. Thus, when the print wait time is adjusted according to the power supply voltage of the image forming apparatus 1, the overshoot can be suppressed even more accurately.

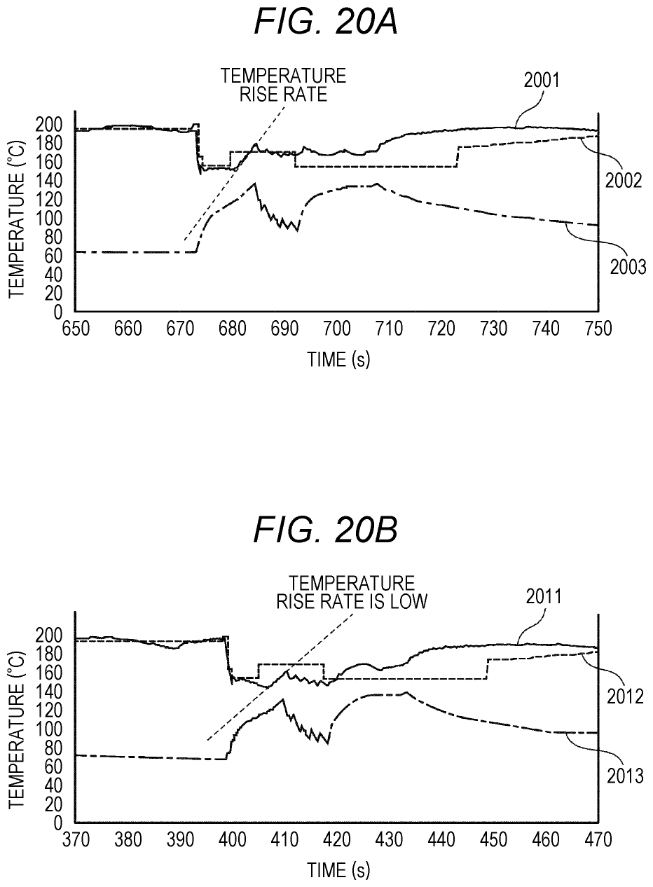

For example, in the period until the temperature (graph 2001) of the fixing belt 300 reaches the print set temperature Ti after the target value (graph 2002) for temperature control of the fixing belt 300 is switched to the print set temperature Ti in a case where the power supply voltage D of the image forming apparatus 1 is 100V as illustrated in FIG. 20A, in a case where the power supply voltage D of the image forming apparatus 1 is 90V with respect to the temperature rise rate of the fixing belt 300 as illustrated in FIG. 20B, the amount of heat generated by the halogen heater 307 is lower compared to the case where the power supply voltage D is 100V. Thus, the temperature rise rate of the fixing belt 300 becomes low in the period until the temperature (graph 2011) of the fixing belt 300 reaches the print set temperature Ti after the target value (graph 2012) for temperature control of the fixing belt 300 is switched to the print set temperature Ti.

Therefore, when the print wait time is fixed (3,100 milliseconds in the example of FIGS. 20A and 20B), in a case where the power supply voltage is 90V, the recording sheet S enters the fixing nip 306 before the fixing belt 300 is sufficiently heated, and thus fixing failure may occur.

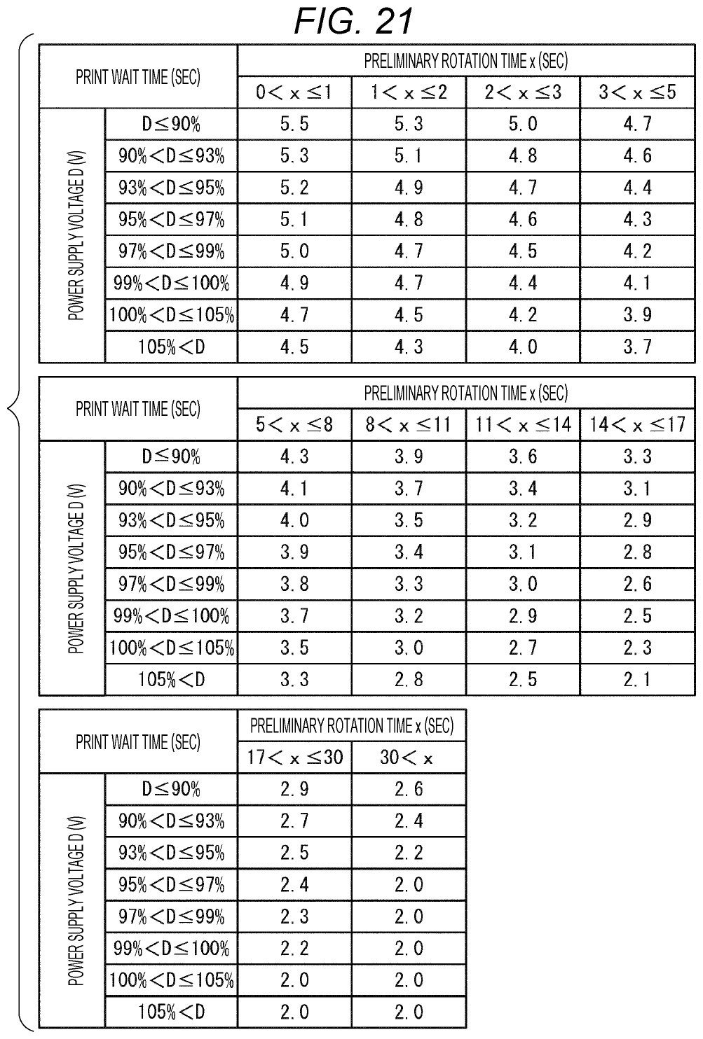

In response to such a problem, a print wait time table as illustrated in FIG. 21 is used to store the print wait time in a non-volatile memory such as the ROM 402 in association with the combination of the numerical range of the preliminary rotation time until the temperature rise start timing and the numerical range of the power supply voltage D, a combination of the numerical range to which the preliminary rotation time and the power supply voltage D belong is specified before the temperature rise start, and the print wait time corresponding to the combination is read, whereby an appropriate print wait time can be specified. The process after the print wait time is specified is the same as in step S606 and subsequent steps in FIG. 6.

In this way, the overshoot and fixing failure can be accurately suppressed even when the preliminary rotation time and the power supply voltage D fluctuate.

(7-4) Although not particularly described in the above-described embodiment, in a case where the temperature difference between the temperature of the fixing belt 300 at the temperature rise start timing and the print set temperature Ti is less than 10° C., the time required for the temperature of the fixing belt 300 to reach the print set temperature Ti is excessively short when considering the time required for upstream processes such as image formation and sheet feeding. Thus, it is difficult to adjust the timing of causing the recording sheet S to enter the fixing nip 306. Therefore, the image formation may be started when the printing instruction is received without adjusting the print wait time.

(7-5) In the above-described embodiment, a case where the heat capacity of the fixing belt 300 is small has been described as an example. However, in a case where the fixing belt 300 having a large heat capacity is used, the temperature rise rate of the fixing belt 300 becomes low, and thus the temperature of the fixing belt 300 can be repeatedly measured by using the temperature sensor 311 to actually measure the temperature rise rate of the fixing belt 300.

Therefore, unlike the above-described embodiment, it is not necessary to estimate the temperature rise rate, and the timing of causing the recording sheet S to enter the fixing nip 306 may be determined by using the actual temperature rise rate.

(7-6) The following can be further considered as a method for estimating the temperature rise rate. In the preliminary rotation period, the target temperature for temperature control of the fixing belt 300 may be changed to the print set temperature Ti for a predetermined short period, the temperature of the fixing belt 300 at the start of the short period and the temperature of the fixing belt 300 at the end of the short period may be acquired by using the temperature sensor 331, and the temperature rise rate may be estimated by dividing the temperature difference by the length of the short period.

The length of the preliminary rotation period is not always constant. Thus, the above-described estimation of the temperature rise rate may be repeated during a certain period, and the print wait time may be determined by using the temperature rise rate which is estimated finally until the temperature rise start timing is reached.

The temperature rise rate obtained by the estimation in this way is a value which reflects the heat storage state of the fixing device 100, the power supply voltage of the image forming apparatus 1, or the environmental conditions. Further, since it is not necessary to carry out an experiment in advance and store the result in the table, the storage capacity in the controller 151 can be saved.

(7-7) In the above-described embodiment, a case where the toner image is heat-fixed to the recording sheet S by using the fixing belt 300 has been described as an example. However, needless to say, the present disclosure is not limited thereto, and a member other than the fixing belt 300, such as a fixing roller, may be used instead of 300.

(7-8) Although not described in detail in the above-described embodiment, the temperature control of the fixing belt 300 at the time of fixing is performed such that the temperature of the fixing belt 300 is within a predetermined allowable temperature range including the print set temperature Ti. Therefore, the overshoot of the temperature of the fixing belt 300 indicates that the temperature of the fixing belt 300 exceeds the upper limit of the allowable temperature range.

(7-9) Although not described in detail in the above-described embodiment, the surface temperature of the pressure roller 302 is warmed to a temperature close to the temperature of the fixing belt 300 by bringing the pressure roller 302 into pressure contact with the fixing belt 300 in the fixing nip 306. On the other hand, the outer peripheral surface of the pressure roller 302 is cooled by coming into contact with the surrounding air after being separated from the fixing nip 306. As a matter of course, when the cooling time increases, the temperature of the outer peripheral surface of the pressure roller 302 becomes low. Thus, the surface temperature of the pressure roller 302 immediately before entering the fixing nip 306 is the lowest.

It is this lowest surface temperature that has the largest effect on the temperature rise rate of the fixing belt 300. Thus, in order to accurately estimate the temperature rise rate of the fixing belt 300, the temperature sensor 317 is desirably arranged on the downstream side in the rotation direction of the pressure roller 302 in the outer peripheral surface of the pressure roller 302 other than the fixing nip, for example, at a position close to the conveying guide 310 such that the temperature sensor 317 can detect the lowest possible surface temperature. The position close to the conveying guide 310 means a portion, which belongs to at least the downstream half in the rotation direction of the pressure roller 302, of the outer peripheral surface of the pressure roller 302 other than the fixing nip.

(7-10) In the above-described embodiment, a case where the image forming apparatus 1 is a tandem type color multi-function peripheral has been described as an example. However, needless to say, the present disclosure is not limited thereto, a color multi-function peripheral other than the tandem type may be used, and a monochrome multi-function peripheral may be used. Further, the same effect can be obtained when the present disclosure is applied to a single-function device such as a printer device, a copying device equipped with a scanner, or a facsimile device having a facsimile communication function.

The image forming apparatus according to the present disclosure is useful as an apparatus capable of accurately suppressing the overshoot of a fixing member and achieving high image quality.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that heat-fixes a toner image by passing a recording sheet through a fixing nip, the image forming apparatus comprising:
a heater that raises a temperature of a fixing member forming the fixing nip; and
a determiner that determines, by using at least one of a heat storage state of a peripheral member that affects a temperature rise rate of the fixing member and a power supply voltage of the image forming apparatus, a print wait period until the recording sheet is caused to enter the fixing nip after a target temperature for temperature control of the fixing member is switched to a heat fixing temperature such that the recording sheet enters the fixing nip before the temperature of the fixing member is raised to exceed an allowable temperature range.

2. The image forming apparatus according to claim 1, comprising:
an acquirer that acquires heat storage information indicating an amount of heat stored in the peripheral member before temperature rise start of the fixing member, wherein
the determiner determines the print wait period to be shorter when the heat storage amount indicated by the heat storage information increases.

3. The image forming apparatus according to claim 2, wherein
the heat storage information is a temperature of the peripheral member.

4. The image forming apparatus according to claim 2, wherein
the heat storage information is history information of a fixing operation.

5. The image forming apparatus according to claim 4, comprising:
a preliminary rotator that controls the temperature of the fixing member to be the target temperature lower than a temperature suitable for heat-fixing, wherein
the history information is a length of time in which the temperature is controlled by the preliminary rotator before the temperature rise start of the fixing member.

6. The image forming apparatus according to claim 1, wherein
the determiner determines the print wait period to be shorter when the power supply voltage increases.
